(19) United States
(12) Patent Application Publication
(10) Pub. No.: US 2025/0187557 A1
(43) Pub. Date: Jun. 12, 2025

(54) EMERGENCY DOOR RELEASE DEVICE

(71) Applicant: EGR Solutions, LLC, Loganville, GA (US)

(72) Inventor: Emanuel Rusu, Loganville, GA (US)

(21) Appl. No.: 18/975,159

(22) Filed: Dec. 10, 2024

Related U.S. Application Data
(60) Provisional application No. 63/608,346, filed on Dec. 11, 2023.

(51) Int. Cl. B60R 21/0132; B60R 21/0136; B60R 21/017

(52) U.S. Cl. CPC B60R 21/0132; B60R 21/0136; B60R 21/017

(57) ABSTRACT

An emergency door release device for a vehicle may include a first sensor to detect a collision and provide a collision indication. A door sensor may detect if a door remains closed after the collision and provide a door indication. A receiver may receive a secondary detonation trigger indication from another device. A processor may analyze the indications to determine if they meet time constraints. A detonator may cause detonation of an explosive to separate the door from the vehicle body if the constraints are met. The device may include additional sensors to detect unsafe conditions. A method and system for releasing a vehicle door using similar components and steps may also be provided.

### RELATED APPLICATION

Under provisions of 35 U.S.C. § 119(e), the Applicant claims benefit of U.S. Provisional Application No. 63/608,346 filed on Dec. 11, 2023, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to a device for emergency door release, and particularly to a device for emergency release for passenger escape.

### BACKGROUND

In some situations, it may be necessary or desirable to leave a vehicle. For example, after a collision, it is important for passengers to leave a vehicle to avoid an unsafe environment and to seek medical attention. However, some accidents may cause a vehicle door to become stuck. For example, metal hardware within the door may break or bend, causing the door not to operate as intended.

In such situations, emergency responders may use specialized hardware such as axes, crowbars, Halligan bars, saws, metal cutting torches, and/or “the jaws of life” (i.e., hydraulic cutters, spreaders, combination spreaders, and/or extension rams) to gain entry to a vehicle so that emergency workers can access passengers and remove them from the vehicle for medical care and safety reasons. However, these tools can be dangerous to the operator and/or the passengers on the interior of the vehicle and can be expensive. Thus, not every emergency response vehicle is equipped with such tools. Equipped vehicles are selected based on, for example, training of the vehicle operators, cost concerns, etc. Accordingly, there may be a delay in removing passengers from a vehicle. This delay can be medically significant, leading to increased injury, or possibly fatality. The time required for properly equipped emergency responders to arrive on scene may be critical in emergency situations.

Conventional vehicle door designs may not adequately address scenarios where rapid egress is required but normal door operation is compromised. Standard door latches and hinges may become jammed or deformed in severe collisions, trapping occupants inside the vehicle. While some vehicles may be equipped with manual emergency release mechanisms, these may still rely on the door's primary structural components functioning properly.

Accordingly, there is a need for a device that can open vehicle doors that have been otherwise made inoperable due to an accident or other severe mechanical failure. There may be a need for improved systems to enable rapid exit from vehicles in emergency situations, even when conventional door opening mechanisms have failed. Ideally, such systems may provide a reliable means of creating an exit path without requiring specialized external equipment or extensive training to operate. Additionally, safeguards may be desirable to prevent accidental or unnecessary activation of emergency exit systems.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In embodiments, an emergency door release device may explode, causing a vehicle door to open after having become jammed shut following an automobile accident, so that the occupant may easily escape from the vehicle or to allow access to the occupant from outside the vehicle (e.g., to provide medical care to the passenger). The door release device may detonate responsive to both an indication that the vehicle has been in a crash and a secondary detonation trigger from a person (e.g., the passenger, emergency personnel, etc.).

Additionally, the device may be configured to detonate, separating the door from the vehicle, when the vehicle is in other unsafe conditions, such as when the vehicle is flooded or when the vehicle is inverted, provided that the device also receives the secondary detonation trigger.

The emergency door release device for a vehicle may include a first detection unit for detecting whether the vehicle has been in an accident or is otherwise in a dangerous situation. As one example, the first detection unit may be an airbag sensor that deploys an airbag when the vehicle experiences an impact greater than a predetermined threshold. A door sensor may be configured to detect at least one of a door open state or a door closed state of at least one door of the vehicle. A receiver may be configured to receive, from an outside source (e.g., a user control within the vehicle, a user device controlled by emergency personnel, etc.) a secondary detonation trigger. An explosive installed inside the door of the vehicle may detonate when the power is supplied to explode, causing the door to at least partially release from the vehicle. A power supply unit may supply power to the explosive via a power supply control signal. The device may detect the door closing state through the door sensing unit for a predetermined time after the first sensing unit detects that the vehicle has been in an accident; thereafter, the receiver may be activated to allow receipt of the secondary trigger. Upon receipt of the secondary trigger, together with detecting the accident and the door remaining in the door closed state, the emergency door release device may detonate the explosive to at least partially separate the door from the vehicle.

The device may further include one or more other sensors configured to detect other unsafe conditions of the vehicle (e.g., a water sensor configured to detect of the vehicle has filled with water, a gyroscope configured to sense if the vehicle is not upright, etc.). When the door closed state is detected through the door detector and at least one of the one or more sensors indicates an unsafe state of the vehicle, the system may activate the receiver to allow for reception of the secondary trigger.

An emergency door release device for use on a vehicle may include a first sensor configured to detect a collision involving the vehicle and, responsive to detecting the collision, provide a collision indication. A door sensor may be configured to detect when a door of the vehicle moves from a closed state to an open state and to provide a door indication when the door of the vehicle does not move from a closed state to an open state within a threshold period of time following the collision. A receiver may be configured to receive, from another device, a secondary detonation trigger indication. A processor may be configured to analyze the secondary detonation trigger indication and one or more of the collision indication or the door indication to determine that the received indications meet one or more time constraints. A detonator may be configured to, responsive to the received indications meeting the one or more time constraints, cause detonation of an explosive to at least partially separate the door of the vehicle from a body of the vehicle.

A method of causing a door to separate from a vehicle may comprise receiving, from a first sensor, an indication of a collision involving the vehicle. The method may include receiving, from a door sensor, an indication that a vehicle door remains closed for a threshold period of time following the collision. The method may involve receiving, at a receiver, a secondary detonation trigger indication from another device. The method may include analyzing the received indications to determine that the received indications meet one or more time constraints. The method may comprise, responsive to determining that the received indications meet the one or more time constraints, causing a detonator to detonate an explosive to at least partially separate the door from a body of the vehicle.

A system for releasing a vehicle door may comprise a collision detection unit configured to detect a collision involving a vehicle. The system may include a door position detection unit configured to detect whether a door of the vehicle opens within a threshold time period after the collision. The system may have a wireless receiver configured to receive an activation signal from an external device. The system may include an explosive charge positioned to separate the door from the vehicle when detonated. The system may comprise a control unit configured to receive indications from the collision detection unit, door position detection unit, and wireless receiver. The control unit may be configured to determine if the received indications satisfy predetermined criteria. The control unit may be configured to trigger detonation of the explosive charge if the predetermined criteria are satisfied.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an emergency door release device consistent with the present disclosure;

FIG. 2 is a flow chart of an example method for using an emergency door release device; and

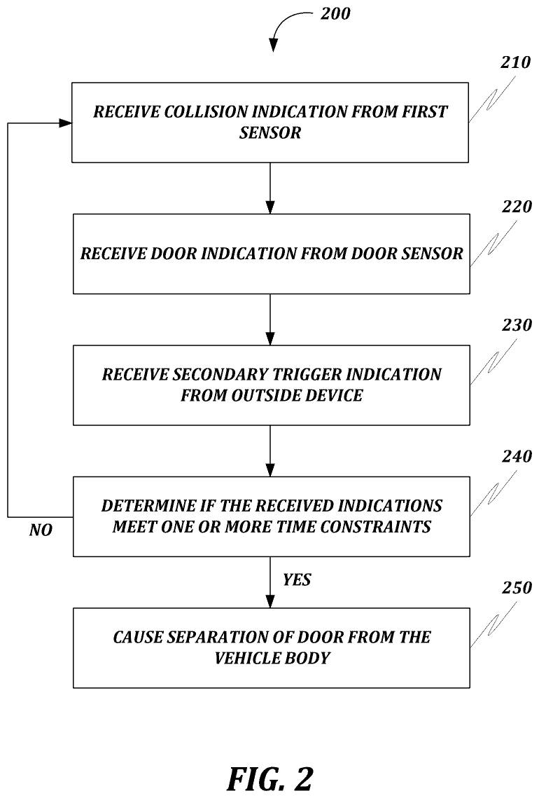

FIG. 3 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of an emergency door release device, embodiments of the present disclosure are not limited to use only in this context.

### I. Apparatus Overview

This overview is provided to introduce a selection of concepts in a simplified form that are further described below. This overview is not intended to identify key features or essential features of the claimed subject matter. Nor is this overview intended to be used to limit the claimed subject matter's scope.

In embodiments, an emergency door release device 100 may receive a signal from a first sensor 110 indicating that a vehicle has been in a collision. For example, an airbag sensor may indicate a vehicle collision that occurs above a threshold speed and/or that causes a deceleration force about a threshold value. The emergency door release device 100 may further include a door sensor 120 that detects whether one or more doors is opened following the detected collision. Responsive to the emergency door release device 100 determining that no vehicle door has been opened for a threshold amount of time following a collision, the device may activate a receiver 130. The receiver 130 may be configured to receive a secondary trigger command. The secondary trigger command may come from various sources. For example, the secondary trigger command may de received from a secondary device (not shown) controlled by a third party, such as a paramedic, EMT, police office, fire officer, and/or the like. Additionally or alternatively, the secondary device may be another component of the vehicle (e.g., activated by a passenger within the vehicle) and/or a device in communication with the vehicle (e.g., a vehicle monitoring and communication system, such as OnStar). Responsive to receipt of the secondary trigger by the receiver 130 following the indication of a collision from the first sensor 110 and the indication that no door has been opened by the door sensor 120, the emergency door release device 100 may activate a detonator 140, causing detonation of one or more explosive charges 150 located at least one portion of one or more vehicle doors. The one or more explosive charges 150 may cause the vehicle door to at least partially separate from the vehicle, allowing passengers within the vehicle to escape therefrom and/or allowing emergency personnel to gain access to the interior of the vehicle to treat passengers located within the vehicle. Importantly, the secondary trigger requires an additional person to be involved in the door release process, helping to ensure that the passengers and any bystanders are in safe locations prior to detonation of the explosive charges.

Embodiments of the emergency door release device 100 may comprise methods, systems, and components comprising, but not limited to, at least one of the following:
A. A First Sensor;
B. A Door Sensor;
C. A Receiver;
D. A Detonator;
E. An Explosive;

In some embodiments, the present disclosure may provide an additional set of components for further facilitating the system. The additional set of components may comprise, but not be limited to:
F. Additional Sensor(s); and
G. An Alarm.

Details with regards to each component are provided below. Although components are disclosed with specific functionality, it should be understood that functionality may be shared between components, with some functions split between components, while other functions duplicated by the components. Furthermore, the name of the component should not be construed as limiting upon the functionality of the component. Moreover, each stage disclosed within each component can be considered independently without the context of the other stages within the same component or different components. Each stage may contain language defined in other portions of this specifications. Each stage disclosed for one component may be mixed with the operational stages of another component. In the present disclosure, each stage can be claimed on its own and/or interchangeably with other stages of other components.

The following depicts an example of a method of a plurality of methods that may be performed by at least one of the aforementioned components. Various hardware components may be used at the various stages of operations disclosed with reference to each component. For example, although methods may be described to be performed by a single apparatus, it should be understood that, in some embodiments, different operations may be performed by different apparatuses in operating in conjunction with each other. Similarly, one apparatus may be employed in the performance of some or all of the stages of the methods. As such, the apparatus may comprise at least one of the architectural components disclosed herein.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the aforementioned components. The method may be embodied as, for example, but not limited to, computer instructions, which when executed, perform the method. The method may comprise the following stages:
Receive from a first sensor, an indication of a vehicle collision;
Receive from a door sensor, an indication that a vehicle door remains closed for a threshold period of time following the collision;
Receive, from a receiver, a secondary detonation trigger indication;
Analyzing the received indications to determine that the indications meet one or more time constraints;
Responsive to determining that the received indications meet the one or more time constraints, causing a detonator to detonate an explosive to at least partially separate one or more doors of the vehicle from the vehicle.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. System Configuration

Embodiments of the present disclosure provide a software and/or hardware platform comprised of a distributed set of components configured to cause separation of one or more doors from a vehicle in an emergency situation. The components of the emergency door release device 100 may include, but need not be limited to:

### A. A First Sensor

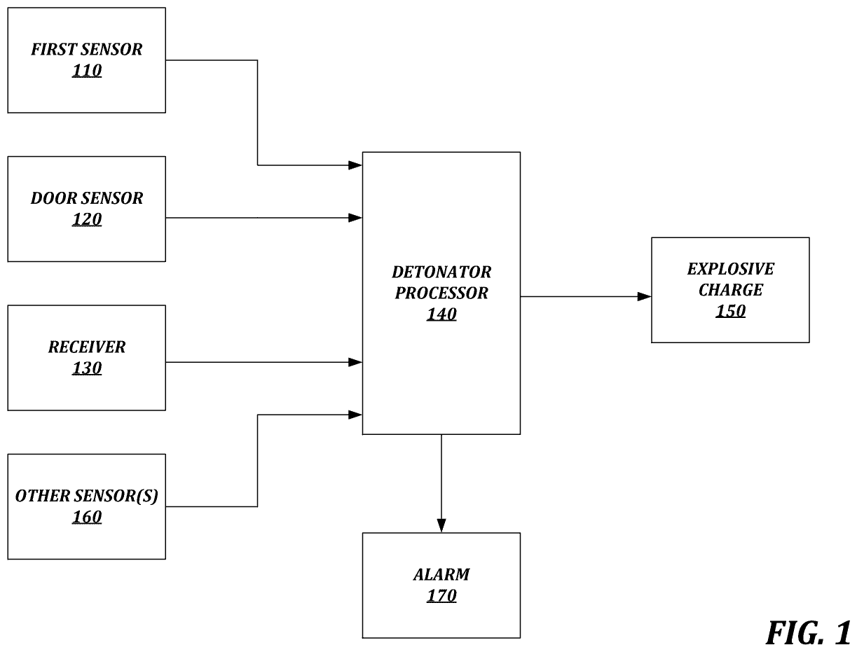

As shown in FIG. 1, the emergency door release device 100 may include a first sensor 110. The first sensor 110 may include, for example, one or more sensors configured to detect a collision involving the vehicle in which the sensor is installed. For example, the first sensor 110 may include one or more of an accelerometer, an impact sensor, a side (door) pressure sensor, a wheel speed sensors, a gyroscope, a brake pressure sensor, and/or the like. In some embodiments the first sensor 110 may be a standalone component of the emergency door release device 100. Additionally of alternatively, the first sensor 110 may include one or more sensors that form a part of a supplemental restraint system, an airbag control unit, and/or any other sensor incorporated into the vehicle.

In some embodiments, the first sensor 110 may generate an alert or other notification in response to a detecting a vehicle collision. In some embodiments, the first sensor 110 may insert (e.g., append, prepend, etc.) a timestamp to the collision notification.

In some embodiments, the first sensor 110 may be configured to detect collisions of varying severity. For example, the first sensor 110 may include an accelerometer capable of measuring accelerations up to 100 g or more. This allows the first sensor 110 to detect both minor fender benders as well as severe high-speed collisions. The accelerometer may measure acceleration along multiple axes to detect impacts from different directions.

The first sensor 110 may include signal processing capabilities to filter and analyze the raw sensor data. For example, the sensor may include a microcontroller that applies algorithms to distinguish actual collision events from other vibrations or impacts that may occur during normal vehicle operation. This helps prevent false positive detections.

In some implementations, the first sensor 110 may include multiple sensing elements working together. For example, it may combine data from an accelerometer, gyroscope, and/or one or more pressure sensors to more accurately characterize collision events. The pressure sensor(s) may detect rapid pressure changes in the vehicle cabin that occur during a crash.

The first sensor 110 may be strategically positioned within the vehicle to optimize collision detection. For example, it may be mounted near the front of the vehicle to detect frontal impacts, with additional sensors near the sides and rear. This distributed sensing approach allows for detection of collisions from any direction.

In some embodiments, the first sensor 110 may have adjustable sensitivity settings. This allows the collision detection threshold to be customized based on factors such as (but not limited to) the specific vehicle model, typical driving conditions, and/or user preferences. The sensitivity may be adjusted dynamically based on current driving conditions.

The first sensor 110 may include self-diagnostic capabilities to help ensure it remains operational. For example, it may periodically run internal tests and report any malfunctions to the vehicle's onboard computer system. This helps ensure the emergency door release system remains functional.

In some implementations, the first sensor 110 may include local data storage to record detailed information about detected collision events. This may include, but need not be limited to, acceleration profiles, impact direction, and/or any other sensor data that may be useful for later analysis.

### B. A Door Sensor

In embodiments, the emergency door release device 100 may include a door sensor 120. The door sensor 120 comprises hardware and/or software configured to detect whether one or more doors is in a closed state or an open state. For example, the door sensor 120 may include one or more sensors for detecting the open or closed state of the driver door and/or one or more passenger doors. In some embodiments, the door sensor 120 may comprise one or more switches having a spring-loaded plunger that is compressed when the door is closed and is released when the door is open. The door sensor 120 may determine a door position based at least in part on a position of the plunger within the sensor. In embodiments, the door sensor 120 may take other forms, including an optical sensor, a magnetic sensor, or any other sensor capable of determining whether the door is open or closed. In embodiments, the door sensor 120 may be active at all times. Alternatively, the door sensor 120 may be activated for a time period following a collision (e.g., following a collision detected by the first sensor 110). In some embodiments, the door sensor 120 may generate an alert or other notification in response to a door changing state (e.g., in response to the door moving from a closed state to an open state).In some embodiments, the door sensor 120 may insert (e.g., append, prepend, etc.) a timestamp to the notification that the door changed state (e.g., that the door moved from a closed state to an open state).

In embodiments, the door sensor 120 may determine whether one or more doors of the vehicle open within a time period following a collision detected by the first sensor 110. For example, the door sensor 120 may detect whether the driver door opens within 3 minutes of the detected collision. In some embodiments, the time period may be a fixed time period. In other embodiments, the time period may be a variable time period and may be selected based on factors including time of day, geolocation where the collision occurred, type of collision, orientation of the vehicle, and./or any other factors associated with the vehicle collision.

In some embodiments, the door sensor 120 may include one or more standalone sensors installed in a vehicle as part of the emergency door release device 100. Alternatively or additionally the door sensor 120 may include one or more pre-existing vehicle sensors for used as part of one or more other systems in the vehicle. The one or more sensors may track the open or closed state of the door continuously or may poll the state of the door at intervals.

In some embodiments, the door sensor 120 may comprise multiple individual sensors, with at least one sensor associated with each door of the vehicle. For example, a four-door vehicle may include four separate door sensors—one for each door. This configuration may allow the emergency door release device 100 to determine which specific door(s) remain closed following a collision.

The door sensor 120 may be configured to detect both transitions from a closed state to an open state and transitions from an open state to a closed state. This bi-directional sensing capability may allow the door sensor 120 to accurately track the current state of each door, even if a door is opened and then closed again following a collision.

In some embodiments, the door sensor 120 may include signal processing capabilities to filter out false positives or negatives. For example, the door sensor 120 may employ debounce logic to prevent brief, unintended changes in door state from being interpreted as actual door openings or closings. This may help ensure the reliability of the door state information provided to other components of the emergency door release device 100.

The door sensor 120 may be integrated with existing vehicle systems in some implementations. For example, the door sensor 120 may interface with the vehicle's body control module and/or central locking system to obtain door state information. This integration may reduce redundancy and leverage existing vehicle sensors and wiring.

In embodiments, the door sensor 120 may include self-diagnostic capabilities. The door sensor 120 may periodically perform internal checks to verify proper operation and report any malfunctions to the vehicle's onboard diagnostic system. This self-monitoring feature may help ensure the reliability of the emergency door release device 100.

The door sensor 120 may be designed to operate in harsh automotive environments. It may be sealed against moisture and contaminants and may be able to withstand extreme temperatures and vibrations typically encountered in vehicle applications. This rugged design may help ensure the door sensor 120 remains functional even after a severe collision.

In some embodiments, the door sensor 120 may include local data storage capabilities. The door sensor 120 may record a history of door state changes, including timestamps. This stored data may be useful for post-incident analysis and/or for troubleshooting system operation.

The sensitivity of the door sensor 120 may be adjustable in some implementations. This may allow the sensor to be calibrated for different vehicle types or to accommodate variations in door designs. As examples, the sensitivity adjustment may be performed during vehicle assembly or as part of a service procedure.

In embodiments, the door sensor 120 may employ redundant sensing elements to improve reliability. As one non-limiting example, each door may be monitored by both a mechanical switch and a magnetic sensor. The emergency door release device 100 may compare readings from both sensors to verify door state and detect any sensor malfunctions.

The door sensor 120 may be designed for easy replacement or servicing. In some embodiments, the sensor may be modular, allowing for quick replacement without requiring extensive disassembly of the vehicle door or surrounding components. This design approach may facilitate maintenance and reduce vehicle downtime.

### C. A Receiver

The emergency door release device 100 may include a receiver 130. The receiver 130 may include hardware and/or software configured to receive a secondary trigger. In embodiments, the receiver may be configured to receive signals from a device (not shown) outside of the emergency door release device 100. For example, the device may be a dedicated hardware device (e.g., a dongle, remote, control, etc.), or a general purpose device having an interface for communicating with the receiver (e.g., a smartphone, computer, etc.). In some embodiments, the device transmitting the secondary trigger may be configured such that the device operator (e.g., emergency a paramedic, EMT, firefighter, police officer, etc.) must be located within the vicinity of the vehicle. This allows the operator to verify the safety of the scene prior to transmitting the trigger. Alternatively, the device may be an onboard computing device operated by a vehicle passenger, allowing the passenger to transmit the secondary trigger either directly (from the onboard computer to the receiver 130) or indirectly (e.g., by providing a command through the onboard computer that causes a third party to transmit the secondary trigger).

In embodiments, the receiver 130 may receive the secondary trigger via near-field communication (NFC), personal area network (e.g., Bluetooth, zigbee, etc.), cellular communication. Wi-Fi, and/or any other technology capable of transmitting a signal from one device to another. The secondary trigger may include a command to open the door. In some embodiments, the secondary trigger may further include a code that can be traced back to a particular user that transmitted the secondary trigger. In some embodiments, the secondary trigger may include a timestamp indicating a time when the secondary trigger was transmitted. Additionally or alternatively, the receiver 130 may insert (e.g., append, prepend, etc.) a timestamp that the secondary trigger was received.

As one example, the receiver 130 may utilize NFC to receive the secondary trigger from an authorized device in close proximity to the vehicle. This could allow emergency responders to activate the door release by tapping or holding an NFC-enabled device near a designated area of the vehicle.

Alternatively or additionally, receiving the secondary trigger may be received via Bluetooth or other personal area network protocols could enable activation from slightly longer ranges, such as from outside the vehicle but within several meters.

In some embodiments, the receiver 130 may not be activated until after the first sensor 110 detects a collision. In some embodiments, the receiver 130 may further not be activated until after the time period lapses without the door sensor 120 detecting any door moving from the closed state to the open state.

For longer-range activation, the receiver 130 may be capable of receiving the secondary trigger via cellular networks or Wi-Fi. This could allow remote activation by authorized personnel or systems. However, additional security measures may be needed for longer-range activation to prevent unauthorized triggering. For example, the receiver 130 may include a verification unit to receive the secondary trigger, which may include an authorization code or encryption to verify (e.g., authenticate, validate) that the second trigger is coming from an authorized source before accepting it. This adds an extra layer of security to help prevent accidental or malicious activation.

The receiver 130 may support multiple communication protocols to provide flexibility in how the secondary trigger can be transmitted. The specific protocol used could be selected based on the scenario and authorized triggering device.

The receiver 130 may log details about received secondary triggers, including the time received, communication protocol used, and any included authorization data. This logging could be useful for post-incident analysis. In some embodiments, the receiver may log both successful and unsuccessful (e.g., events with an incorrect authorization code) secondary trigger reception events. This may be useful in tracking malicious trigger activations.

To conserve power, the receiver 130 may normally remain in a low-power standby mode. It may only fully activate to listen for secondary triggers after the first sensor 110 detects a collision and the door sensor 120 indicates the doors remain closed after a set time period. This helps ensure the system is ready to receive a secondary trigger when needed while minimizing unnecessary power draw.

### D. A Detonator

The emergency door release device 100 may include a detonator 140. In embodiments, the detonator may receive commands from one or more of the first sensor 110, the door sensor 103, and/or the receiver 130. The detonator may determine that the first sensor 110 detected a vehicle collision, and that subsequent to the vehicle collision a period of time elapsed without the door sensor 120 detecting opening of a door on the vehicle. The detonator 140 may further detect that a secondary trigger signal is received at the receiver 130. in some embodiments, (e.g., where the operator of the device is specified with the secondary trigger signal), the detonator may validate whether the specified operator is authorized to transmit the secondary trigger. For example, there may be a list of operators that are permitted to transmit the secondary trigger (e.g., a “whitelist”) and/or a list of operators that are explicitly not allowed to transmit a secondary trigger (e.g., a “blacklist”).

In some embodiments, the detonator 140 may determine whether the received signals satisfy one or more criteria. For example, the detonator 140 may use timestamps embedded in each notification to determine that a collision occurred, that a period of time has elapsed following the collision without a door transitioning from a closed state to an open state, and that a secondary trigger message has been received, subsequent to the collision, from an authorized operator. In some embodiments, the timestamp of the secondary trigger may be used to verify that the secondary trigger is received within a particular time of the collision notification (e.g., less than a 30 minute time difference between the collision notification and the secondary trigger notification). This can help to ensure that the emergency door release device 100 is used only during emergency circumstances.

Upon determination that the one or more conditions are satisfied (e.g., that the vehicle was involved in a collision, that no doors were opened during a defined time period following the collision, and that a secondary trigger was received from an authorized source subsequent to the crash), the detonator may cause the explosive charge 150 to detonate. Causing the detonation may include, for example, creating and/or transmitting an electrical signal to the explosive charge.

The detonator 140 may include safeguards to prevent unintended activation, such as requiring multiple confirmations or using encrypted communications. It may also log all trigger events and activations for later analysis.

In some embodiments, the detonator 140 may interface with additional vehicle systems or sensors to gather more data about the collision and vehicle state before initiating detonation. This allows for a more informed decision on whether door separation is necessary and safe to perform.

### E. An Explosive Charge

The explosive charge 150 may be for example, a primary secondary explosive that rapidly coverts from solid to gas, applying pressure on a particular portion of the vehicle in response to receipt of a signal from the detonator 140, similar to those used to deploy airbags and/or in seatbelt pretensioners. In embodiments, the explosive charge 150 may be a shaped charge configured to direct the force generated by detonation in one or more particular direction relative to the orientation of the charge.

One or more explosive charges 150 may be positioned in the vehicle such that, upon detonation, the explosive charge can cause a vehicle door to at least partially separate from the vehicle. As non-limiting examples, the explosive charge 150 may be positioned near one or more door hinges, one or more door latches, and/or at other locations around the door frame, such that force applied by detonation of the explosive charge 150 causes the door to separate from the vehicle.

The explosive charge 150 may comprise a shaped charge configured to direct the force generated by detonation in one or more particular directions relative to the orientation of the charge. This allows the explosive force to be focused on specific structural elements of the door assembly to achieve separation.

In some embodiments, multiple smaller explosive charges may be used instead of a single larger charge. For example, separate charges could be positioned at each door hinge and at the door latch. This distributed approach may provide more controlled and localized separation of the door components.

The explosive material used in the charge 150 may be selected to provide rapid gas generation and pressure buildup when detonated, while minimizing the risk of fire or other secondary effects. Possible explosive materials may include, but are not limited to, RDX, HMX, PETN, or other high-energy compounds commonly used in automotive safety systems like airbags and seatbelt pretensioners.

The size and configuration of the explosive charge 150 may be tailored based on the specific vehicle door design and materials. Factors including (but not limited to) door mass, hinge and latch strength, and/or desired separation force may be accounted for in determining the appropriate explosive yield. The explosive charge 150 may be housed in a containment structure to direct the explosive force and contain any fragments.

Positioning and/or shaping of the explosive charge 150 may be used to achieve door separation while reducing or minimizing the risk of injury to vehicle occupants and/or persons nearby the vehicle (e.g., emergency responders, witnesses, pedestrians, etc.) from the explosive event itself. The goal is to produce a controlled structural failure of door attachment points rather than a large undirected explosion.

### F. One or More Additional Sensors

In some embodiments, one or more additional sensors 160 may optionally be included in the emergency door release device 100 to provide notifications to the detonator 140. The one or more additional sensors 160 may be configured to detect various emergency conditions or unsafe states of the vehicle beyond just collision detection. This allows the emergency door release device 100 to potentially activate in scenarios where a collision has not occurred, but the vehicle occupants may still require emergency egress. For example, the one or more additional sensors may include a water sensor to determine if the vehicle has become submerged in water, a gyroscope to determine if the vehicle is stuck in an inverted or otherwise abnormal orientation, a temperature sensor, smoke detector, or other sensor capable of determining if the vehicle is on fire, and/or any other sensor useful in determining a non-collision emergency condition of a vehicle. In some embodiments, the one or more other sensors 160 may generate an alert or other notification in response to a detecting a vehicle emergency condition. In some embodiments, the one or more other sensors 160 may insert (e.g., append, prepend, etc.) a timestamp to the emergency notification. The emergency notification from the one or more other sensors may be used in place of one or more of the collision notification from the first sensor 110 and/or the door open notification from the door sensor 120.

As a first non-limiting example, the one or more additional sensors 160 may include a water sensor configured to detect if the vehicle has become submerged in water. This may comprise a conductivity sensor or other type of moisture detection sensor placed at one or more locations in the vehicle cabin or other areas likely to flood if the vehicle enters a body of water. If the water sensor detects water ingress above a certain threshold, it may generate an alert signal to the detonator 140.

As another example, the additional sensor 160 may be a gyroscope or accelerometer configured to detect if the vehicle is in an inverted or otherwise abnormal orientation. For instance, if the vehicle has rolled over onto its roof or side, the gyroscope may detect this abnormal orientation and generate an alert signal. This may allow activation of the emergency door release even if no collision was detected, such as in the case of a vehicle slowly rolling down an embankment. In other embodiments, the orientation sensor may prevent activation of the explosive charge for downward facing doors (e.g., door blocked from opening by the ground), as activation where the door is physically prevented from separating by the weight of the vehicle may cause force to be redirected in unintended ways.

Additionally or alternatively, the one or more additional sensors 160 may include temperature sensors, smoke detectors, or other sensors capable of determining if the vehicle is on fire or at risk of catching fire. Rapid temperature increases or the presence of smoke in the cabin could trigger these sensors to generate an alert signal.

In embodiments with one or more additional sensors 160, the emergency door release device 100 may be configured to use input from these sensors in determining whether conditions warrant activation of the explosive charge 150 to separate the vehicle door. For example, the detonator 140 may analyze input from the one or more additional sensors 160 in addition to or instead of the collision indication from the first sensor 110 and the door closed indication from the door sensor 120.

By incorporating one or more additional sensors 160, the emergency door release device 100 may provide enhanced safety functionality to address a wider range of potential emergency scenarios beyond just collision detection. This allows the device to potentially save lives in situations like vehicle submersion, rollover accidents, or vehicle fires where rapid escape may be critical even in the absence of a detectable collision event.

### G. An Alarm

In some embodiments, the emergency door release device 100 may optionally include an alarm 170. The alarm 170 may include hardware and/or software configured to provide an audible and/or visual alert prior to detonation of the explosive charge 150. The alarm may provide the alert to one or more of the interior cabin of the vehicle and/or the vehicle exterior. In some embodiments, the alarm may indicate which door is to be released using the emergency door release device 100. The alarm may be broadcast immediately prior to and/or during the detonation process.

The alarm 170 may comprise one or more speakers configured to emit an audible warning tone and/or voice message. The one or more speakers may be positioned in various locations within the vehicle interior and/or exterior. In some embodiments, the alarm 170 may utilize existing vehicle speakers, such as those used for the vehicle audio system.

Additionally or alternatively, the alarm 170 may include one or more visual indicators, such as flashing lights. The visual indicators may be positioned on the interior and/or exterior of the vehicle. In some embodiments, the alarm 170 may utilize existing vehicle lighting systems such as hazard lights and/or interior dome lights.

The alarm 170 may be electrically connected to and controlled by the detonator 140. Upon determining that detonation criteria have been met, the detonator 140 may be configured to activate the alarm 170 for a predetermined time period prior to triggering the explosive charge 150. This predetermined time period may be, for example, 5-10 seconds to allow occupants and bystanders to prepare for the door separation.

In some embodiments, the alarm 170 may be configured to provide directional indications, such as by activating only certain speakers or lights near the door(s) that will be separated. This may help guide occupants toward the soon-to-be opened exit, and/or allow occupants to move away from the door prior to detonation.

The alarm 170 may be powered by the vehicle's electrical system and/or may include a backup power source such as a battery to ensure operation even if vehicle power is compromised. The alarm 170 may also include safeguards to prevent unintended activation, such as electrical isolation from other vehicle systems.

### III. Apparatus/System Use

Embodiments of the present disclosure provide a system operative by a set of methods comprising instructions configured to operate the aforementioned components in accordance with the methods. The following depicts an example of a method of a plurality of methods that may be performed by at least one of the aforementioned components. Various hardware components may be used at the various stages of operations disclosed with reference to each component.

For example, although methods may be described to be performed by a single component, it should be understood that, in some embodiments, different operations may be performed by different components in operative relation with one another. For example, an apparatus may be employed in the performance of some or all of the stages disclosed with regard to the methods. As such, the apparatus may comprise at least one architectural component disclosed herein.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the method without altering or deterring from the fundamental scope of the depicted methods and systems disclosed herein.

Consistent with embodiments of the present disclosure, a method may be performed by at least one of the aforementioned components. The method may be embodied as, for example, but not limited to, computer instructions, which when executed, perform the method. The method may include receiving, at an emergency door release device, an indication of a vehicle collision from a first sensor. The emergency door release device may receive, from a door sensor, an indication that a vehicle door has not transitioned to an open state (e.g., the door remains closed) within a threshold period of time following the collision. The emergency door release device may further receive, at a receiver, a secondary detonation trigger indication from an outside device. The emergency door release device may analyze the received indications to determine that the indications meet one or more time constraints and, responsive to determining that the received indications meet the time constraints, the emergency door release device may cause a detonator to detonate an explosive to at least partially separate one or more doors of the vehicle from the vehicle.

The method 200 may start at stage 210, where an emergency door release device receives an indication of a vehicle collision. In embodiments, the vehicle collision notification may be received from one or more collision sensors disposed in a vehicle. The vehicle collision notification may include a timestamp indicating the time at which a particular sensor (of the one or more collision sensors) detected a collision condition.

In stage 220, the emergency door release device may wait to determine if a vehicle door transitions from a closed state to an open state. If a door sensor detects that the door transitions to an open state, the system may determine that the vehicle door can be opened by a user and is not stuck closed. If a particular time period elapses following the detected collision without the door opening, the system may determine that the door is unable to be opened. In some embodiments, at the end of the particular time period, a door sensor may send a door notification indicating that the vehicle doors have not opened. The notification may include a timestamp indicating the time the notification was sent.

In stage 230, the emergency door release device may receive a secondary trigger notification. The emergency door release device may include a wireless receiver capable of receiving the secondary trigger notification. For example, the wireless receiver may be capable of receiving notifications using near field communication, personal area networks (e.g., Bluetooth, zigbee, etc.), Wi-Fi, cellular communications (e.g., EDGE, GPRS, LTE, 5G, etc.), RF communications, and/or any other wireless communications capable of transmitting the secondary trigger notification data. The secondary trigger notification may be received from a device outside of the emergency door release device. For example, the device may be a dedicated hardware device (such as a remote control), a general purpose hardware device running a specialized application (such as a smartphone, a tablet computer, a laptop, a desktop computer, or any other computing device), a vehicle onboard computer, and/or the like.

In some embodiments, the receiver may be configured such that it only receives secondary trigger notification after the emergency door release device receives a collision notification and/or after receiving a notification that the doors of a vehicle did not open for the predetermined time period following the collision notification.

The secondary trigger notification may include a request to release the door from the vehicle. The secondary trigger notification allows the holder of the outside device (e.g., emergency personnel such as a paramedic, EMT, firefighter, or police officer) to assess the environment both within the vehicle cabin and surrounding the vehicle to determine if separation through detonation is needed. In embodiments, the secondary trigger notification may include additional data including (but not limited to) an operator of the device the transmitted the secondary trigger notification, an identifier of the device that transmitted the secondary trigger notification, a time of transmission of the secondary trigger notification, and/or any other information related to the secondary trigger notification.

In stage 240, the emergency door release device may process received notifications (e.g., the collision notification received at stage 210, the door notification received at stage 220, and/or the secondary trigger notification received at stage 230). The assessment may include determining a presence and/or an ordering of the received signals. For example, the device may determine that a collision notification was received at a first time, that a door notification was received after a predetermined time period elapsed following the collision notification, and that the secondary trigger notification was received subsequent to the collision notification. In some embodiments (e.g., where the receiver is not activated until after receipt of the collision notification and the door notification), receipt of a secondary trigger notification may be sufficient to indicate that all notifications have been received. In some embodiments, the device may further determine that the secondary trigger notification is received within a threshold time period (e.g., 10 minutes, 30 minutes, etc.) following the collision notification.

The device may further apply one or more other requirements to the notifications. For example, the device may disregard secondary trigger notifications transmitted by unauthorized parties. As another example, the device may compare a geographic location of the device that provided the secondary trigger notification to a geographic location of the vehicle to determine that the device is located in the vicinity of the vehicle.

If one or more of the notifications are not received, or do not meet any other requirements, the emergency door release device may disregard one or more received notifications and return to an idle state, waiting to receive additional notifications.

Alternatively, responsive to processing the notifications and determining that all requirements are met, the device may cause release of the door in stage 250. Release of the door may be achieved, for example, by detonation of one or more explosive charges disposed in the vicinity of the door (e.g., near the door hinge, near the door latch, and/or at any other position around the door configured to effect separation of the door from the vehicle body). In embodiments, causing release of the door may include causing detonation of the one or more explosive charges. Causing detonation may include, for example, supplying the one or more explosive charges with a spark or other source to detonate the explosive.

The door may thereby be released from the vehicle body, permitting passenger egress and/or permitting emergency personnel to access passengers trapped therein.

Although the stages above are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the method without altering or deterring from the fundamental scope of the depicted methods and systems disclosed herein.

### IV. Platform Arcitecture

Embodiments of the present disclosure provide a hardware and software platform operative as a distributed system of modules and computing elements.

One or more elements of the emergency door release device 100 may be embodied as, for example, but not be limited to, a website, a web application, a desktop application, a backend application, and a mobile application compatible with a computing device 300. The computing device 300 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;
Elements of the emergency door release device 100 may be hosted on a centralized server or a cloud computing service. It should be understood that, in some embodiments, different operations of the method 200 may be performed by one or more computing devices 300 in operative communication on at least one network.

Embodiments of the present disclosure may comprise a system having a central processing unit (CPU) 320, a bus 330, a memory unit 340, a power supply unit (PSU) 350, and one or more Input/Output (I/O) units. The CPU 320 coupled to the memory unit 340 and the plurality of I/O units 360 via the bus 330, all of which are powered by the PSU 350. It should be understood that, in some embodiments, each disclosed unit may actually be a plurality of such units for redundancy, high availability, and/or performance purposes. The combination of the presently disclosed units is configured to perform the stages of any method disclosed herein.

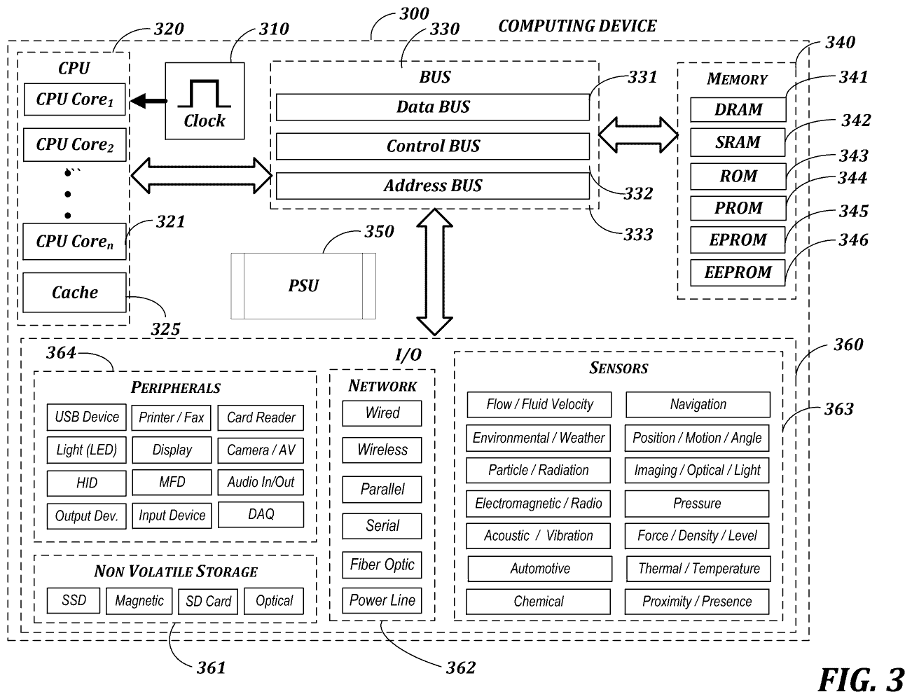

FIG. 3 is a block diagram of a system including computing device 300. Consistent with an embodiment of the disclosure, the aforementioned CPU 320, the bus 330, the memory unit 340, a PSU 350, and the plurality of I/O units 360 may be implemented in a computing device, such as computing device 300 of FIG. 3. Any suitable combination of hardware, software, or firmware may be used to implement the aforementioned units. For example, the CPU 320, the bus 330, and the memory unit 340 may be implemented with computing device 300 or any of other computing devices 300, in combination with computing device 300. The aforementioned system, device, and components are examples and other systems, devices, and components may comprise the aforementioned CPU 320, the bus 330, and the memory unit 340, consistent with embodiments of the disclosure.

At least one computing device 300 may be embodied as any of the elements illustrated in all of the attached figures. A computing device 300 does not need to be electronic, nor even have a CPU 320, nor bus 330, nor memory unit 340. The definition of the computing device 300 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 300, especially if the processing is purposeful.

With reference to FIG. 3, a system consistent with an embodiment of the disclosure may include a computing device, such as computing device 300. In some configurations, the computing device 300 may include at least one clock module 310, at least one CPU 320, at least one bus 330, and at least one memory unit 340, at least one PSU 350, and at least one I/O 360 module, wherein I/O module may be comprised of, but not limited to a non-volatile storage sub-module 361, a communication sub-module 362, a sensors sub-module 363, and a peripherals sub-module 364.

In a system consistent with an embodiment of the disclosure, the computing device 300 may include the clock module 310, known to a person having ordinary skill in the art as a clock generator, which produces clock signals. Clock signals may oscillate between a high state and a low state at a controllable rate and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 320, the central component of modern computers, which relies on a clock signal. The clock 310 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 300 may use a “clock multiplier” which multiplies a lower frequency external clock to the appropriate clock rate of the CPU 320. This allows the CPU 320 to operate at a much higher frequency than the rest of the computing device 300, which affords performance gains in situations where the CPU 320 does not need to wait on an external factor (like memory 340 or input/output 360). Some embodiments of the clock 310 may include dynamic frequency change, where, the time between clock edges can vary widely from one edge to the next and back again.

In a system consistent with an embodiment of the disclosure, the computing device 300 may include the CPU 320 comprising at least one CPU Core 321. In other embodiments, the CPU 320 may include a plurality of identical CPU cores 321, such as, but not limited to, homogeneous multi-core systems. It is also possible for the plurality of CPU cores 321 to comprise different CPU cores 321, such as, but not limited to, heterogeneous multi-core systems, big.LITTLE systems and some AMD accelerated processing units (APU). The CPU 320 reads and executes program instructions which may be used across many application domains, for example, but not limited to, general purpose computing, embedded computing, network computing, digital signal processing (DSP), and graphics processing (GPU). The CPU 320 may run multiple instructions on separate CPU cores 321 simultaneously. The CPU 320 may be integrated into at least one of a single integrated circuit die, and multiple dies in a single chip package. The single integrated circuit die and/or the multiple dies in a single chip package may contain a plurality of other elements of the computing device 300, for example, but not limited to, the clock 310, the bus 330, the memory 340, and I/O 360.

The CPU 320 may contain cache 322 such as but not limited to a level 1 cache, a level 2 cache, a level 3 cache, or combinations thereof. The cache 322 may or may not be shared amongst a plurality of CPU cores 321. The cache 322 sharing may comprise at least one of message passing and inter-core communication methods used for the at least one CPU Core 321 to communicate with the cache 322. The inter-core communication methods may comprise, but not be limited to, bus, ring, two-dimensional mesh, and crossbar. The aforementioned CPU 320 may employ symmetric multiprocessing (SMP) design.

The one or more CPU cores 321 may comprise soft microprocessor cores on a single field programmable gate array (FPGA), such as semiconductor intellectual property cores (IP Core). The architectures of the one or more CPU cores 321 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 321, for example, but not limited to Instruction-level parallelism (ILP) such as, but not limited to, superscalar pipelining, and Thread-level parallelism (TLP).

Consistent with the embodiments of the present disclosure, the aforementioned computing device 300 may employ a communication system that transfers data between components inside the computing device 300, and/or the plurality of computing devices 300. The aforementioned communication system will be known to a person having ordinary skill in the art as a bus 330. The bus 330 may embody internal and/or external hardware and software components, for example, but not limited to a wire, an optical fiber, various communication protocols, and/or any physical arrangement that provides the same logical function as a parallel electrical bus. The bus 330 may comprise at least one of a parallel bus, wherein the parallel bus carries data words in parallel on multiple wires; and a serial bus, wherein the serial bus carries data in bit-wise serial form. The bus 330 may embody a plurality of topologies, for example, but not limited to, a multidrop/electrical parallel topology, a daisy chain topology, and connected by switched hubs, such as a USB bus. The bus 330 may comprise a plurality of embodiments, for example, but not limited to:
Internal data bus (data bus) 331/Memory bus
Control bus 332
Address bus 333
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 300 may employ hardware integrated circuits that store information for immediate use in the computing device 300, known to persons having ordinary skill in the art as primary storage or memory 340. The memory 340 operates at high speed, distinguishing it from the non-volatile storage sub-module 361, which may be referred to as secondary or tertiary storage, which provides relatively slower-access to information but offers higher storage capacity. The data contained in memory 340, may be transferred to secondary storage via techniques such as, but not limited to, virtual memory and swap. The memory 340 may be associated with addressable semiconductor memory, such as integrated circuits consisting of silicon-based transistors, that may be used as primary storage or for other purposes in the computing device 300. The memory 340 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 341, Static Random-Access Memory (SRAM) 342, CPU Cache memory 325, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 343, Programmable ROM (PROM) 344, Erasable PROM (EPROM) 345, Electrically Erasable PROM (EEPROM) 346 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 300 may employ a communication system between an information processing system, such as the computing device 300, and the outside world, for example, but not limited to, human, environment, and another computing device 300. The aforementioned communication system may be known to a person having ordinary skill in the art as an Input/Output (I/O) module 360. The I/O module 360 regulates a plurality of inputs and outputs with regard to the computing device 300, wherein the inputs are a plurality of signals and data received by the computing device 300, and the outputs are the plurality of signals and data sent from the computing device 300. The I/O module 360 interfaces with a plurality of hardware, such as, but not limited to, non-volatile storage 361, communication devices 362, sensors 363, and peripherals 364. The plurality of hardware is used by at least one of, but not limited to, humans, the environment, and another computing device 300 to communicate with the present computing device 300. The I/O module 360 may comprise a plurality of forms, for example, but not limited to channel I/O, port mapped I/O, asynchronous I/O, and Direct Memory Access (DMA).

Consistent with the embodiments of the present disclosure, the aforementioned computing device 300 may employ a non-volatile storage sub-module 361, which may be referred to by a person having ordinary skill in the art as one of secondary storage, external memory, tertiary storage, off-line storage, and auxiliary storage. The non-volatile storage sub-module 361 may not be accessed directly by the CPU 320 without using an intermediate area in the memory 340. The non-volatile storage sub-module 361 may not lose data when power is removed and may be orders of magnitude less costly than storage used in memory 340. Further, the non-volatile storage sub-module 361 may have a slower speed and higher latency than in other areas of the computing device 300. The non-volatile storage sub-module 361 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (361) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 300 may employ a communication sub-module 362 as a subset of the I/O module 360, which may be referred to by a person having ordinary skill in the art as at least one of, but not limited to, a computer network, a data network, and a network. The network may allow computing devices 300 to exchange data using connections, which may also be known to a person having ordinary skill in the art as data links, which may include data links between network nodes. The nodes may comprise networked computer devices 300 that may be configured to originate, route, and/or terminate data. The nodes may be identified by network addresses and may include a plurality of hosts consistent with the embodiments of a computing device 300. Examples of computing devices that may include a communication sub-module 362 include, but are not limited to, personal computers, phones, servers, drones, and networking devices such as, but not limited to, hubs, switches, routers, modems, and firewalls.

Two nodes can be considered networked together when one computing device 300 can exchange information with the other computing device 300, regardless of any direct connection between the two computing devices 300. The communication sub-module 362 supports a plurality of applications and services, such as, but not limited to World Wide Web (WWW), digital video and audio, shared use of application and storage computing devices 300, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 362 may comprise a plurality of size, topology, traffic control mechanisms and organizational intent policies. The communication sub-module 362 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 300 may employ a sensors sub-module 363 as a subset of the I/O 360. The sensors sub-module 363 comprises at least one of the device, module, or subsystem whose purpose is to detect events or changes in its environment and send the information to the computing device 300. Sensors may be sensitive to the property they are configured to measure, may not be sensitive to any property not measured but be encountered in its application, and may not significantly influence the measured property. The sensors sub-module 363 may comprise a plurality of digital devices and analog devices, wherein if an analog device is used, an Analog to Digital (A-to-D) converter must be employed to interface the said device with the computing device 300. The sensors may be subject to a plurality of deviations that limit sensor accuracy. The sensors sub-module 363 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 300 may employ a peripherals sub-module 364 as a subset of the I/O 360. The peripheral sub-module 364 comprises ancillary devices uses to put information into and get information out of the computing device 300. There are 3 categories of devices comprising the peripheral sub-module 364, which exist based on their relationship with the computing device 300, input devices, output devices, and input/output devices. Input devices send at least one of data and instructions to the computing device 300. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 300. Output devices convert electronically generated information into a form that can be presented to humans. Input/output devices that perform both input and output functions. It should be understood by a person having ordinary skill in the art that the ensuing are non-limiting embodiments of the aforementioned peripheral sub-module 364:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 300. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 300 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 300. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC).
Input/Output Devices may further comprise, but not be limited to, touchscreens, networking devices (e.g., devices disclosed in network sub-module 362), data storage devices (non-volatile storage 361), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as an example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. An emergency door release device for use on a vehicle, comprising:
a first sensor configured to detect a collision involving the vehicle and, responsive to detecting the collision, provide a collision indication;
a door sensor configured to detect when a door of the vehicle moves from a closed state to an open state and to provide a door indication when the door of the vehicle does not move from a closed state to an open state within a threshold period of time following the collision;
a receiver configured to receive, from another device, a secondary detonation trigger indication;
a processor configured to analyze the secondary detonation trigger indication and one or more of the collision indication or the door indication to determine that the received indications meet one or more time constraints; and
a detonator configured to, responsive to the received indications meeting the one or more time constraints, cause detonation of an explosive to at least partially separate the door of the vehicle from a body of the vehicle.

2. The emergency door release device of claim 1, wherein the first sensor comprises at least one of an accelerometer, an impact sensor, a side pressure sensor, a wheel speed sensor, a gyroscope, or a brake pressure sensor.

3. The emergency door release device of claim 1, wherein the door sensor comprises at least one of a switch, an optical sensor, or a magnetic sensor.

4. The emergency door release device of claim 1, wherein the receiver is configured to receive the secondary detonation trigger indication via at least one of near-field communication, Bluetooth, cellular communication, or Wi-Fi.

5. The emergency door release device of claim 1, wherein the processor is further configured to validate that a source of the secondary detonation trigger indication is authorized to trigger detonation.

6. The emergency door release device of claim 1, further comprising an alarm configured to provide at least one of an audible alert or a visual alert prior to detonation of the explosive.

7. The emergency door release device of claim 1, wherein the explosive is positioned near at least one of a door hinge or a door latch.

8. The emergency door release device of claim 1, further comprising at least one additional sensor configured to detect an unsafe condition of the vehicle.

9. The emergency door release device of claim 8, wherein the at least one additional sensor comprises at least one of a water sensor configured to detect if the vehicle is submerged or a gyroscope configured to detect if the vehicle is inverted.

10. The emergency door release device of claim 8, wherein the processor is further configured to analyze an indication from the at least one additional sensor in determining whether to cause detonation of the explosive.

11. A method of causing a door to separate from a vehicle, the method comprising:
receiving, from a first sensor, an indication of a collision involving the vehicle;
receiving, from a door sensor, an indication that a vehicle door remains closed for a threshold period of time following the collision;
receiving, at a receiver, a secondary detonation trigger indication from another device;
analyzing the received indications to determine that the received indications meet one or more time constraints; and
responsive to determining that the received indications meet the one or more time constraints, causing a detonator to detonate an explosive to at least partially separate the door from a body of the vehicle.

12. The method of claim 11, further comprising validating that a source of the secondary detonation trigger indication is authorized to trigger detonation.

13. The method of claim 11, further comprising providing at least one of an audible or visual alert prior to detonating the explosive.

14. The method of claim 11, further comprising:
receiving, from at least one additional sensor, an indication of an unsafe condition of the vehicle; and
analyzing the indication of the unsafe condition in determining whether to detonate the explosive.

15. The method of claim 14, wherein the unsafe condition comprises at least one of the vehicle being submerged in water or the vehicle being inverted.

16. A system for releasing a vehicle door, comprising:
a collision detection unit configured to detect a collision involving a vehicle;
a door position detection unit configured to detect whether a door of the vehicle opens within a threshold time period after the collision;
a wireless receiver configured to receive an activation signal from an external device;
an explosive charge positioned to separate the door from the vehicle when detonated; and
a control unit configured to:
receive indications from the collision detection unit, door position detection unit, and wireless receiver;
determine if the received indications satisfy predetermined criteria; and
trigger detonation of the explosive charge if the predetermined criteria are satisfied.

17. The system of claim 16, wherein the predetermined criteria include receiving the activation signal within a specified time period after detecting the collision.

18. The system of claim 16, further comprising a verification unit configured to authenticate the external device before the control unit triggers detonation.

19. The system of claim 16, further comprising at least one additional sensor configured to detect an emergency condition of the vehicle.

20. The system of claim 19, wherein the control unit is further configured to consider input from the at least one additional sensor in determining whether to trigger detonation of the explosive charge.
